(19) United States
(12) Patent Application Publication
(10) Pub. No.: US 2024/0216214 A1
(43) Pub. Date: Jul. 4, 2024

(54) NEGATIVE PRESSURE SUCKING MASSAGE DEVICE

(71) Applicant: Zhi DUAN, Yuanjiang City, Hunan Province (CN)

(72) Inventor: Zhi DUAN, Yuanjiang City, Hunan Province (CN)

(73) Assignee: Zhi DUAN, Yuanjiang City, Hunan Province (CN)

(21) Appl. No.: 18/126,897

(22) Filed: Mar. 27, 2023

(30) Foreign Application Priority Data
Dec. 28, 2022 (CN) 202211694029.5

(51) Int. Cl. A61H 19/00

(52) U.S. Cl. CPC A61H 19/34; A61H 19/32

(57) ABSTRACT

A negative pressure sucking massage device is provided that includes: a housing, a negative pressure generation unit and a power source The negative pressure generation unit includes a hollow coil cylinder, a metal coil, and a sliding magnet block provided within and closely fitting with the coil cylinder The negative pressure generation unit and the power source are housed within the housing. In operation of the negative pressure sucking massage device, the negative pressure generation unit energizes the metal coil with electricity to generate a magnetic field resulting in: driving the sliding magnet block to reciprocate to form a piston effect, evacuating air to form a negative pressure to produce a sucking effect on the stimulated portion(s) continuously, and thus achieving excellent and comfortable effects of health care and physiotherapy. Moreover, the apparatus is simple in structure, stable in performance and low in operation noise.

### CROSS-REFERENCE TO RELATED APPLICATION

This application claims priority to Chinese Patent Application No. CN202211694029.5, filed on Dec. 28, 2022, the disclosure of which is incorporated herein by reference in its entirety.

### TECHNICAL FIELD

The present invention relates to a massage device for female health care, especially to a negative pressure sucking massage device.

### BACKGROUND OF THE INVENTION

It is a complicated physiological process for female sexual function, related to several aspects, such as nerves, mental factors, endocrine functions, sexual organ health, and so on. The health care for female sexual function is very important, and is increasingly concerned and emphasized by more and more females and society.

Known massage devices for female health care are generally formed by two portions: a handle and a massage head. A motor is used to drive the massage head to vibrate and swing to stimulate the sensitive portion(s), thus achieving the effects of health care and physiotherapy. See, e.g., Chinese patents of CN2254744Y and CN204636936U.

However, the known massage devices for female health care depend excessively on high-frequency mechanical movement and are poor in sensing and health care effects, while their requirements for the power mechanism, such as safety and reliability, are very high.

### SUMMARY OF THE INVENTION

In accordance with the present disclosure, a completely new negative pressure sucking massage device is provided, which can provide excellent massage effect on the stimulated portion(s) by a negative pressure formed by repeated air evacuation.

In accordance with the present disclosure, a negative pressure sucking massage device is provided that comprises: a housing, a negative pressure generation unit and a power source. The negative pressure generation unit comprises a hollow coil cylinder, a metal coil, and a sliding magnet block provided within and closely fitting with the coil cylinder. The coil cylinder is provided on each of its two ends with a magnet, and the two magnets are mounted such that a side of the magnet faces a side of the sliding magnet block having the same polarity to generate a repulsion force to each other. The negative pressure generation unit and the power source are housed within the housing.

After the metal coil is energized with electricity, a magnetic field is formed such that the sliding magnet block reciprocates as a piston within the hollow coil cylinder to form a negative pressure with sucking sense, and when the sliding magnet block reciprocates rapidly, the negative pressure with sucking sense is formed continuously.

By way of example, the housing has a portion of flexible material, such as flexible rubber or resin, which is to be in contact with a massaged portion.

By way of example, the sliding magnet block has a surface covered with a layer of flexible material or is plated with a layer of Ni, for both sealing clearance and facilitating free sliding of the magnet block.

By way of example, the coil cylinder is designed on its outer surface with a coil site which comprises a smooth surface and is formed of a nonconductive wear-resistant material.

By way of example, the negative pressure generation unit further comprises a part provided therein with a through hole which allows airflow to pass through, and a part provided with an airflow port.

By way of example, the magnets on the two ends of the coil cylinder are provided within the parts, respectively.

By way of example, the airflow port of the part provided with the airflow port is protruded and extended to a surface of the housing. The airflow port may be an inlet port or an outlet port.

In the negative pressure sucking massage device according to the present disclosure, the negative pressure generation unit energizes the metal coil with electricity to generate a magnetic field, driving the sliding magnet block to reciprocate to form a piston effect, evacuating air to form a negative pressure to produce a sucking effect on the stimulated portion(s) continuously, and thus achieving excellent and comfortable effects of health care and physiotherapy. Moreover, the apparatus of the present disclosure is simple in structure, stable in performance and low in operation noise, and has very obvious advantages with respect to the prior massage devices.

### DESCRIPTION OF THE DRAWINGS

FIG. 1 is a section view of a negative pressure sucking massage device according to an illustrative example of the present disclosure; and

FIG. 2 is an exploded view of the negative pressure sucking massage device according to an illustrative example of the present disclosure.

### DESCRIPTION OF EXEMPLARY EMBODIMENTS

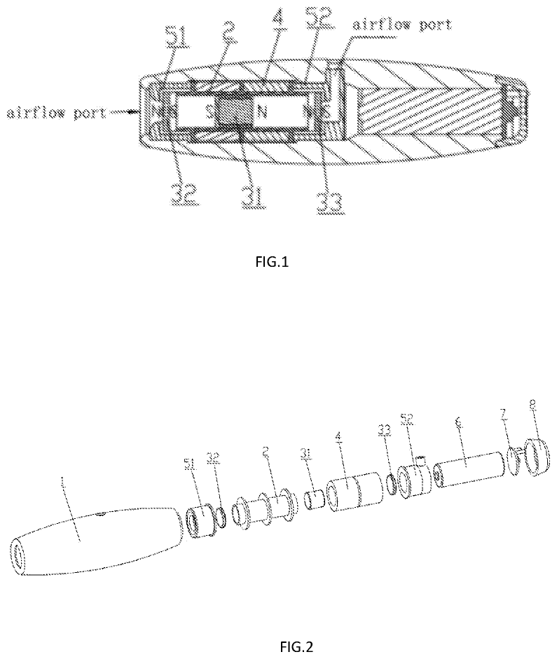

As shown in FIGS. 1 and 2, a negative pressure sucking massage device according to the present disclosure comprises: a negative pressure generation unit, a housing 1 and a power source 6. The housing 1 may be made of any material(s) which should at least meet the requirement that the portion in contact with the human body is of a flexible material, such as rubber or resin, and so on. In the present embodiment, a silica gel is used.

The negative pressure generation unit comprises a hollow coil cylinder 2, a metal coil 4, and a sliding magnet block 31 provided within and closely fitting with the coil cylinder. The power source 6 may be a disposable battery or a rechargeable battery. When the massage device is in use, its button is pressed down, and the metal coil 4 is energized with electricity to form an electromagnetic field. The sliding magnet block 31 provided therein will reciprocate within a cavity of the coil cylinder 2. When the sliding magnet block 31 is moving right in a horizontal direction, the volume of cavity on the left becomes larger to form a negative pressure with sucking sense. When the sliding magnet block reciprocates rapidly, the negative pressure with sucking sense is formed continuously, thus acting on and stimulating massaged portion(s).

The sliding magnet block 31 may be a magnet with a surface polished to be smooth. However, with consideration of sealing performance and negative pressure effect, perhaps more preferably, the magnet surface is covered with a layer of flexible material used for sealing the clearance between the magnet block and the coil cylinder, without affecting free sliding of the magnet block. By way of example, the magnet surface is plated with a layer of nickel (Ni). The clearance between the sliding magnet block, covered with a layer of flexible material or plated with a layer of Ni, and the coil cylinder is, by way of example less than 0.05 mm, preferably about 0.03 mm.

During experimentation, it was found that when the coil cylinder is provided on each of its two ends with a magnet, it is possible to generate a repulsion force to the sliding magnet block such that the sliding magnet block moves more stably and produces less noise. Therefore, by way of example, the coil cylinder 2 is provided on each of its two ends with magnets 32, 33. The two magnets 32, 33 are mounted such that a side of the magnet faces a side of the sliding magnet block 31 having the same polarity. For example, the S pole of the magnet 32 faces the S pole of the sliding magnet block 31, and the N pole of the magnet 33 faces the N pole of the sliding magnet block 31.

FIG. 2 is an exploded view of a specific embodiment of the present disclosure. It comprises in sequence (starting from its front end): a housing 1, a part 51 provided therein with a through hole which allows airflow to pass through, a magnet 32, a coil cylinder 2, a sliding magnet block 31, a metal coil 4, a magnet 33, a part 52 provided with an airflow port, a battery 6, a printed circuit board assembly (PCBA) 7 and a seat 8. When the massage device is operating, it is necessary for the part 52, provided with an airflow port, to discharge airflow from or introduce airflow into the housing. The airflow port may be protruded and extended to a surface of the housing. Herein, the airflow port may be an inlet port or an outlet port. The parts 51 and 52 are arranged on the two ends of the coil cylinder 2, respectively, and can be provided with hollow assembly holes to facilitate assembly with the coil cylinder 2. The two magnets 32, 33 on the two ends of the coil cylinder 2 may be provided within the parts 51 and 52, respectively.

The massage device in the present disclosure may be made in any shape according to the requirement, such as, for example, a spindle shape or a L shape.

The above description is only for illustratively providing examples of the present disclosure. It should be pointed out that for those skilled in the art, it is possible to make improvements and/or modifications to the disclosed apparatus, without departing from the principle(s) of the present disclosure, which should be considered as being within the protection scope of the present disclosure.

What is claimed is:

1. A negative pressure sucking massage device comprising:
a housing;
a negative pressure generation unit; and
a power source,
wherein the negative pressure generation unit comprises:
a hollow coil cylinder,
a metal coil, and
a sliding magnet block provided within and closely fitting with the coil cylinder,
wherein the coil cylinder is provided on each of a first end and a second end with a first magnet and a second magnet (32, 33), respectively, and
wherein the first magnet and the second magnet are mounted such that a side of each of the first magnet and the second magnet faces a side of the sliding magnet block having the same polarity to generate a repulsion force to each other; and
wherein the negative pressure generation unit and the power source are housed within the housing.

2. The negative pressure sucking massage device according to claim 1, wherein, after the metal coil is energized with electricity, a magnetic field is formed such that the sliding magnet block reciprocates as a piston within the coil cylinder to form a negative pressure with sucking sense, and
wherein when the sliding magnet block reciprocates rapidly, the negative pressure with sucking sense is formed continuously.

3. The negative pressure sucking massage device according to claim 2, wherein the sliding magnet block has a surface covered with a layer of flexible material for both sealing clearance and facilitating free sliding of the magnet block.

4. The negative pressure sucking massage device according to claim 2, wherein the sliding magnet block has a surface plated with a layer of Ni, for both sealing clearance and facilitating free sliding of the magnet block.

5. The negative pressure sucking massage device according to claim 2, wherein a clearance between the sliding magnet block and the coil cylinder is less than 0.05 mm.

6. The negative pressure sucking massage device according to claim 1, wherein the coil cylinder is designed on an outer surface with a coil site comprising a smooth surface and is formed of a nonconductive wear-resistant material.

7. The negative pressure sucking massage device according to claim 1, wherein the coil cylinder is wound on an outer circumference with one or more groups of the metal coils that can generate an electromagnetic field after energization with electricity.

8. The negative pressure sucking massage device according to claim 1, wherein the negative pressure generation unit further comprises:
a first part provided therein with a through hole that allows airflow to pass through, and
a second part provided with an airflow port,
wherein the first part and the second part are arranged on a first end and a second end of the coil cylinder, respectively.

9. The negative pressure sucking massage device according to claim 8, wherein the airflow port is an inlet port or an outlet port.

10. The negative pressure sucking massage device according to claim 8, wherein the first magnet and the second magnet, on the two ends of the coil cylinder are provided within the first part and the second part, respectively.

11. The negative pressure sucking massage device according to claim 8, wherein the airflow port is protruded and extended to a surface of the housing.

12. The negative pressure sucking massage device according to claim 1, wherein the housing has a portion of flexible material in contact with a massaged portion.
